(19) United States
(12) Patent Application Publication
(10) Pub. No.: US 2012/0292172 A1
(43) Pub. Date: Nov. 22, 2012

(54) PUSH SWITCH INCORPORATING AN INTEGRATED CIRCUIT ELEMENT

(75) Inventors: CHIA-CHIN SU, New Taipei (TW); SHUN-JUNG CHUANG, New Taipei (TW)

(73) Assignee: HON HAI PRECISION INDUSTRY CO., LTD., New Taipei (TW)

(21) Appl. No.: 13/476,214

(22) Filed: May 21, 2012

(30) Foreign Application Priority Data
May 20, 2011 (TW) 100117835

(51) Int. Cl. H01H 13/50; H01H 1/14

(52) U.S. Cl. 200/534

(57) ABSTRACT

A push switch (100) includes an insulative housing (1) defining a first space (111) communicating with an upper face (11) thereof and a second space (121) communicating with a lower face (12) thereof, a number of contacts (2) retained in the insulative housing, a dome sheet (3) positioned in the first space, a metal shell (5) covering the insulative housing, a button (4) positioned between the metal shell and the dome sheet, and an IC element (6) assembled in the second space. The contacts includes a grounding contact (21), a switch contact (22), and a signal contact (23). The dome sheet constantly contacts the grounding contact. The button is operable for actuating the dome sheet to connect with the switch contact. The IC element contacts the grounding contact, the switch contact, and the signal contact. The IC element undertakes high current.

### BACKGROUND OF THE INVENTION

1. Field of the Invention

The present invention relates generally to a push switch, and more particularly to a push switch undertaking high current.

2. Description of Related Arts

Taiwan Patent No. M363062 discloses a push switch comprising an insulative housing, a first immovable contact having a plurality of peripheral contacting pads, a second immovable contact having a central contacting pad encircled by the peripheral contacting pads, and an integral dome sheet having a circular edge portion constantly connecting with the peripheral contacting pads and a central portion suspending over the central contacting pad. The push switch further comprises a button. A user operates the button to actuate the central portion of the dome sheet. Therefore, the central portion of the dome sheet connects with the central contacting pad of the second immovable contact. Therefore, the first and second immovable contacts are connected with each other via the dome sheet for signal transmission. The dome sheet is metallic. Connection between the first and second immovable contacts is limited because the metallic dome sheet usually may not undertake high current, e.g., over 3A. On the other hand, it is known for push-button switches of a type seen in U.S. Pat. No. 5,001,316 to have a printed circuit terminal board in cooperation with a planar electrically conductive circular, rotatable contact plate.

Hence, a push switch undertaking high current is desired.

### SUMMARY OF THE INVENTION

Accordingly, an object of the present invention is to provide a push switch undertaking high current.

To achieve the above object, a push switch includes an insulative housing defining a first space communicating with an upper face thereof and a second space communicating with a lower face thereof, a number of contacts retained in the insulative housing, a dome sheet positioned in the first space, a metal shell covering the insulative housing, a button positioned between the metal shell and the dome sheet, and an IC element assembled in the second space. The contacts includes a grounding contact, a switch contact, and a signal contact. The dome sheet constantly contacts the grounding contact. The button is operable for actuating the dome sheet to connect with the switch contact. The IC element contacts the grounding contact, the switch contact, and the signal contact. The IC element undertakes high current.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of a push switch in a preferred embodiment of the present invention;

FIG. 2 is another perspective, assembled view of the push switch;

FIG. 3 is a perspective, fully exploded view of the push switch;

FIG. 4 is another perspective, fully exploded view of the push switch;

FIG. 5 is a perspective view of the present invention when a plurality of contacts is retained in an insulative housing;

FIG. 6 is a perspective, exploded view of the present invention when an IC element removes from an association of the contacts and the insulative housing;

FIG. 7 is a first cross-sectional view of the push switch taken along line 7-7 of FIG. 1; and

FIG. 8 is a second cross-sectional view of the push switch taken along line 8-8 of FIG. 1.

### DETAILED DESCRIPTION OF THE PREFERRED EMBODIMENT

Reference will now be made in detail to the preferred embodiment of the present invention.

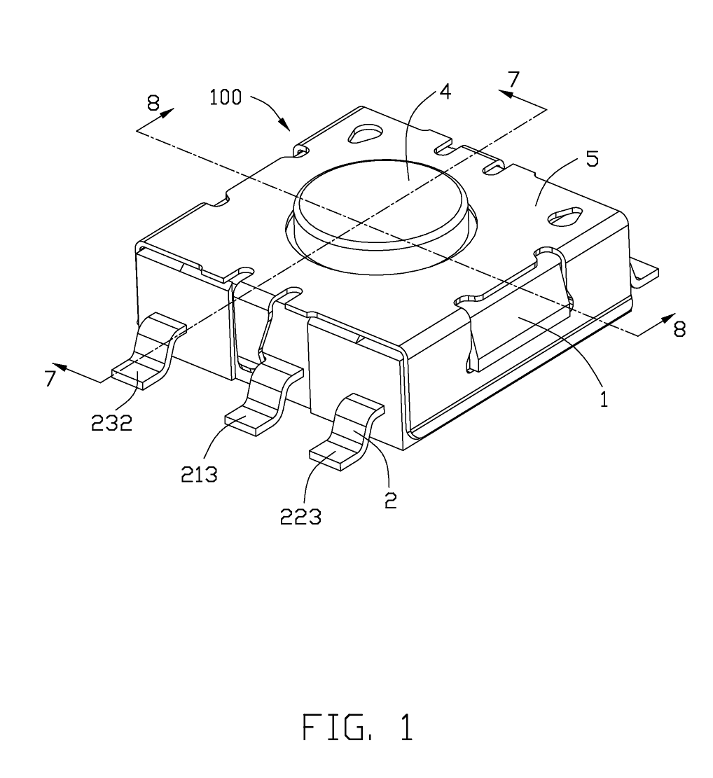

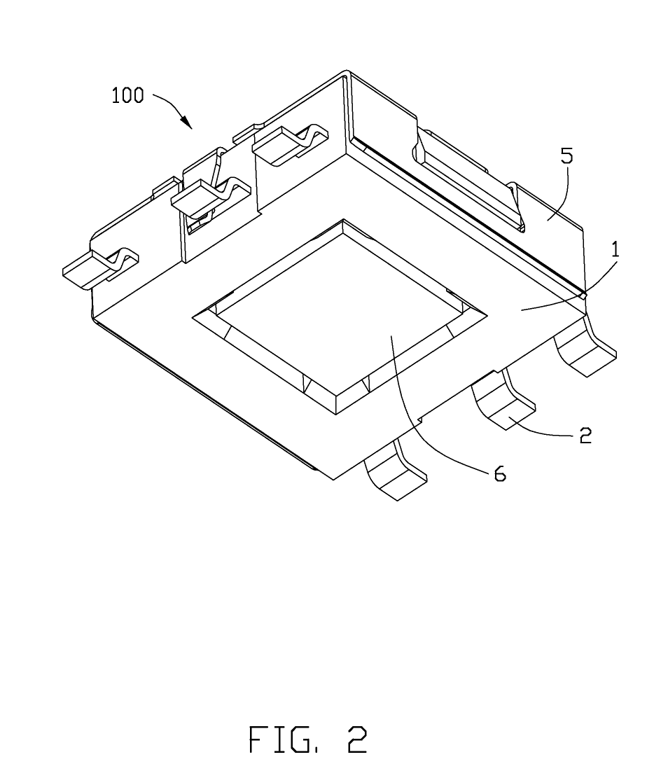

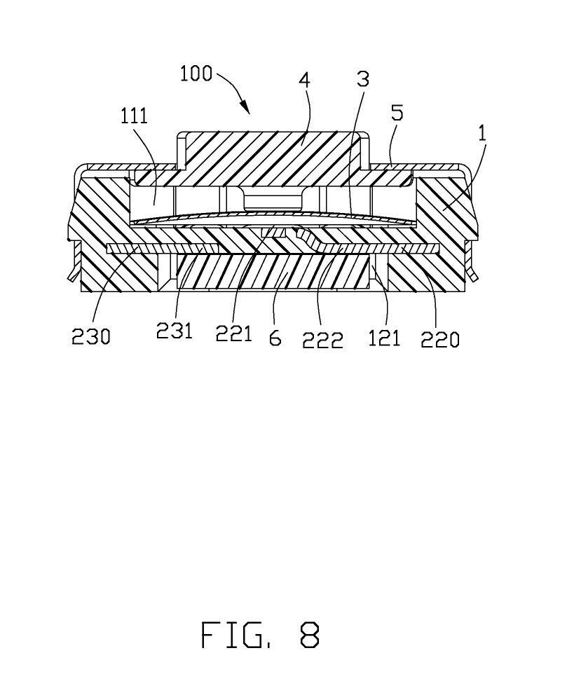

Referring to FIGS. 1-8, a push switch 100 in accordance with the present invention, comprises an insulative housing 1, a plurality of immovable contacts 2 retained in the insulative housing 1, a movable contact or dome sheet 3 positioned over the immovable contacts 2, a button 4 for actuating the dome sheet 3 to connect with one of the immovable contacts 2, a metal shell 5 covering the insulative housing 1, and an IC (Integrated Circuit) element 6 assembled at a bottom of the insulative housing 1.

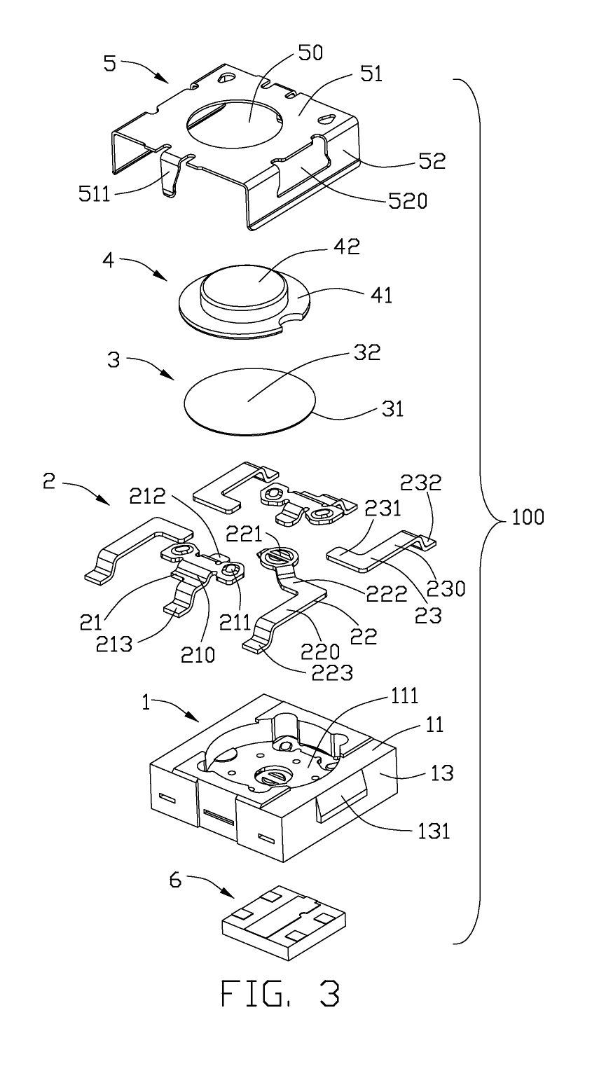

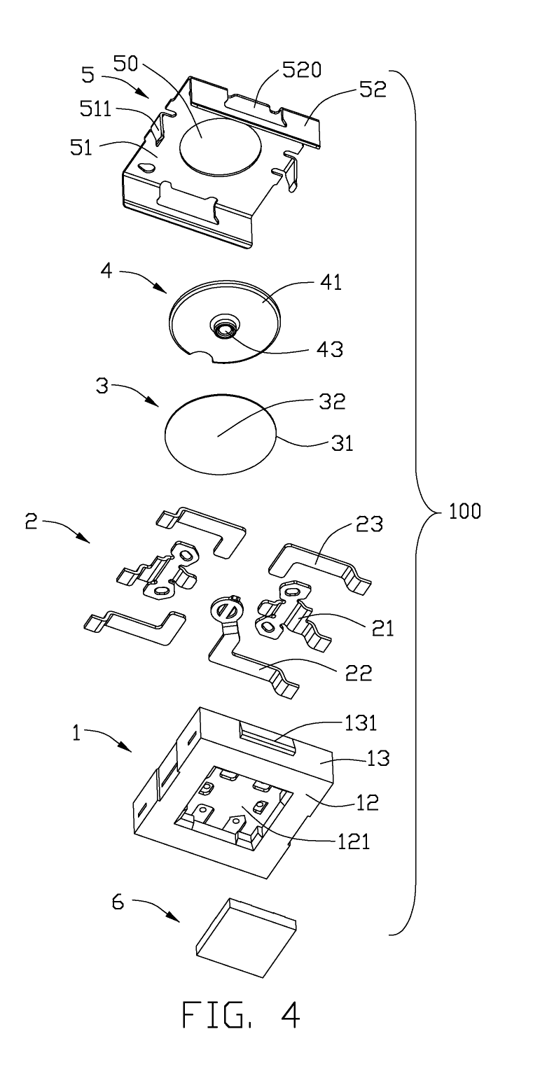

Referring to FIGS. 3 and 4, the insulative housing 1 comprises an upper face 11, a lower face 12, and a plurality of lateral faces 13 connecting with the upper face 11 and the lower face 12. The insulative housing 1 defines a first space 111 opening to the upper face 11 and a second space 121 opening to the lower face 12. One pair of the lateral faces 13 each form a protrusion 131 extending outwardly for securing purpose.

Referring to FIGS. 3 and 4, the immovable contacts 2 are retained in the insulative housing 1, preferably by way of insert molding. The immovable contacts 2 comprise one or more grounding contacts 21, a switch contact 22, and a number of signal contacts 23. For example, depending on specific applications, two opposing ground contacts (GND), one switch contact (SW), one control contact (Control), one voltage in contact (Vin), and one voltage out contact (Vout) may be provided. Each grounding contact 21 comprises a first retaining portion 210, a pair of first contacting pads 211, a first contacting portion 212, and a first soldering portion 213. The first contacting pads 211, the first contacting portion 212, and the first soldering portion 213 extend from the first retaining portions 210 in different directions. The switch contact 22 comprises a second retaining portion 220, a second contacting portion 222 extending from the second retaining portion 220, a second contacting pad 221 formed at a distal end of the second contacting portion 222, and a second soldering portion 223 extending from the second retaining portion 220 opposite to the second contacting portion 222. Each signal contact 23 comprises a third retaining portion 230, a third contacting portion 231, and a third soldering portion 232. The third contacting portion 231 and the third soldering portion 232 extend oppositely from the third retaining portion 230.

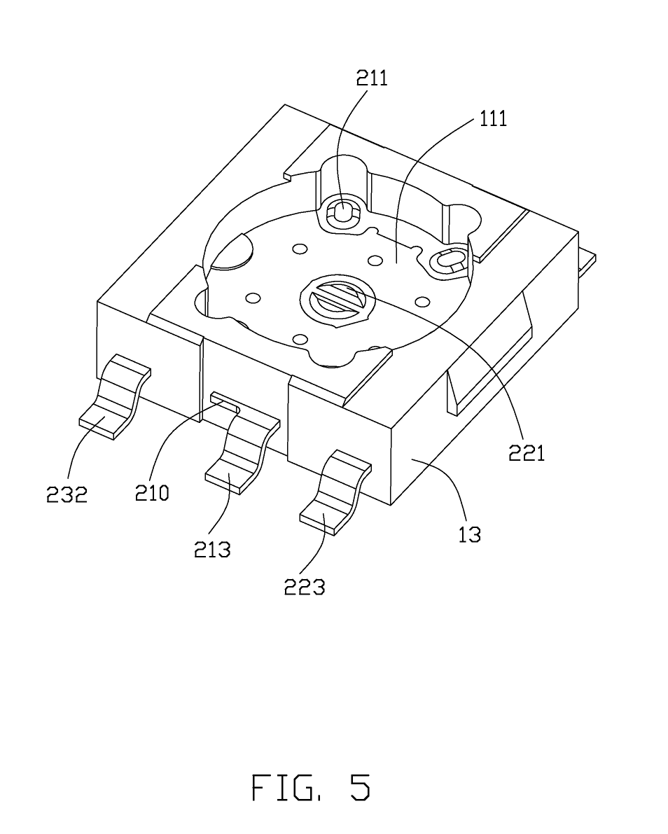

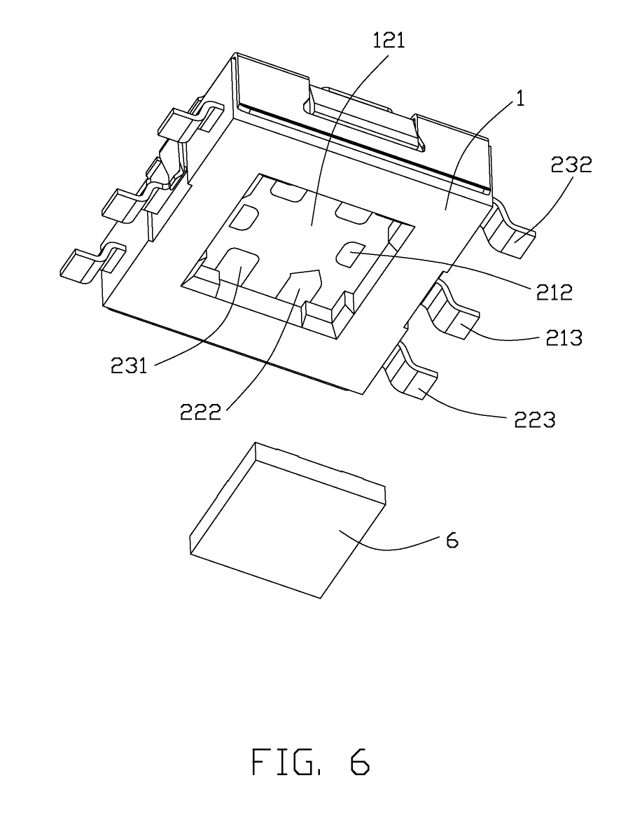

Referring to FIGS. 3-6 and particularly to FIGS. 5 and 6, the first contacting pads 211 of the grounding contacts 21 and the second contacting pad 221 of the switch contact 22 extend into the first space 111. The first contacting pads 211 are arranged peripherally and are exposed in the first space 111. The second contacting pad 221 is located in the middle of the first space 111 and is encircled by the first contacting pads 211. The first retaining portions 210, the second retaining portion 220, and the third retaining portion 230 are insert-molded in the lateral faces 13 of the insulative housing 1. Particularly, the first retaining portions 210 are partly exposed out of the corresponding lateral faces 13. The first contacting portions 212, the second contacting portion 222, and the third contacting portion 231 are disposed in the second space 121.

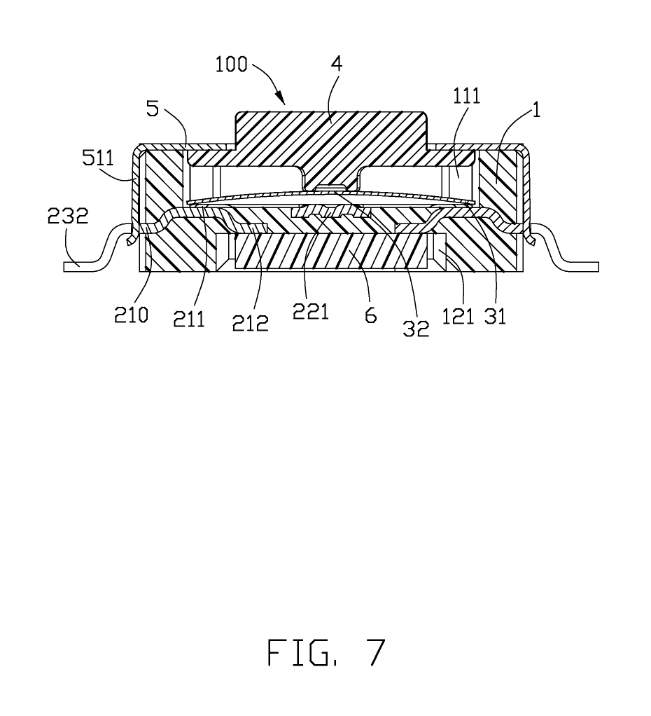

Referring to FIGS. 3 and 7, the dome sheet 3 comprises a circular edge portion 31 and a central portion 32. The circular edge portion 31 is constantly connected with the first contacting pads 211 of the grounding contacts 21. The central portion 32 suspends over the second contacting pad 221 of the switch contact 22. The central portion 32 is connected with the second contacting pad 221 when the central portion 32 is deflected by the button 4.

Referring to FIGS. 3 and 4, the button 4 is located above the dome sheet 3. The button 4 comprises a main portion 41, an operating portion 42 extending upwardly from the main portion 41, and an actuating portion 43 extending downwardly from the main portion 41. The actuating portion 43 is positioned on the central portion 32 of the dome sheet 3.

Referring to FIG. 7, the metal shell 5 is frame shaped. The metal shell 5 comprises a base portion 51 and a pair of side portions 52 extending laterally and downwardly from the base portion 51. The base portion 51 defines an opening 50 through which the first space 111 communicates with outside of the push switch 100. Therefore, the operating portion 42 of the button 4 extends out of the first space 111 through the opening 50. The main portion 41 of the button 4 is positioned below the base portion 51. The main portion 41 has a diameter greater than that of the opening 50 for preventing the button 4 from disengaging from the first space 111 when the push switch 100 is reversedly positioned. Each side portion 52 defines a cutout 520. The cutouts 520 engage with the protrusions 131 for securing the metal shell 5 to the insulative housing 1. The metal shell 5 forms a pair of hook portions 511 extending downwardly from opposite front and back edges of the base portion 51. The hook portions 511 engage with the first retaining portions 210 of the grounding contacts 21. Therefore, static charge generated on the metal shell 5 is timely discharged.

Referring to FIG. 6, the IC element 6 is received in the second space 121 of the insulative housing 1. The IC element 6 constantly contacts with the first contacting portions 212, the second contacting portion 222, and the third contacting portion 231. The IC element 6 itself may be of known ASIC chip and preferably is MOS (Metal-Oxide-Semiconductor) based. The IC element 6 is designed to undertake high current, e.g., 20A-30A. In practical use, the IC element 6 is further designed to have additional functions, such as current limiting, over-voltage protection, over-temperature protection, inrush current suppression, etc., that can be suitably implemented by application-specific integrated circuits and/or firmwares in a manner known to those skilled in this art.

When the push switch 100 is in use, a user pushes down the operating portion 42 of the button 4. Accordingly, the actuating portion 43 of the button 4 deflects the dome sheet 3. The central portion 32 of the dome sheet 3 is connected with the second contacting pad 221 of the switch contact 22. Therefore, the grounding contacts 21 and the switch contact 22 are electrically connected with each other to turn the switch on. An “ON” signal is transmitted to activate the IC element 6. Although not specifically labeled, it is understood that the IC element may be correspondingly provided with one central ground pad (GND), one switch contact (SW), one control contact (Control), one voltage in contact (Vin), and one voltage out contact (Vout), as can be clearly seen in FIG. 3. Since the IC element 6 constantly contacts with the two first contacting portions 212, the single second contacting portion 222, and the three third contacting portion 231, the signal contacts 23 (e.g., Vin, Vout, and Control contacts) perform their function through the IC element 6. To deactivate, the user releases the operating portion 42 of the button 4 and the central portion 32 of the dome sheet 3 restores back, i.e., parting away from the second contacting pad 221 of the switch contact 22. Thereafter, the grounding contacts 21 are disconnected from the switch contact 22 and an “OFF” signal is transmitted to the IC element 6 to disable it.

In the push switch 100 of the present invention, the signal contacts 23 are enabled by the IC element 6 and the IC element 6 integrates a MOS in order to undertake high current. Therefore, the push switch 100 has a long life cycle even used in an over-current, over-voltage, or over-temperature conditions.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A push switch, comprising:
an insulative housing defining a first space communicating with an upper face thereof and a second space communicating with a lower face thereof;
a plurality of contacts retained in the insulative housing, the contacts comprising a grounding contact, a switch contact, and a signal contact;
a dome sheet positioned in the first space and constantly contacting the grounding contact;
a metal shell covering the insulative housing;
a button positioned between the metal shell and the dome sheet and operable for actuating the dome sheet to connect with the switch contact; and
an integrated circuit (IC) element for undertaking high current, the IC element being assembled in the second space, and contacting the grounding contact, the switch contact, and the signal contact.

2. The push switch as claimed in claim 1, wherein the grounding contact comprises a plurality of first contacting pads arranged peripherally and exposed to the first space.

3. The push switch as claimed in claim 2, wherein the dome sheet comprises a circular edge portion constantly contacting the first contacting pads.

4. The push switch as claimed in claim 2, wherein the switch contact comprises a second contacting pad and the second contacting pad is encircled by the first contacting pads.

5. The push switch as claimed in claim 4, wherein the dome sheet has a central portion contacting the second contacting pad when the button pushes down the dome sheet.

6. The push switch as claimed in claim 1, wherein the grounding contact has a retaining portion retained with the insulative housing and the metal shell has a hook portion engaging with the retaining portion.

7. The push switch as claimed in claim 1, wherein the IC element is Metal-Oxide-Semiconductor based.
